(19) United States
(12) Patent Application Publication
(10) Pub. No.: US 2012/0099204 A1
(43) Pub. Date: Apr. 26, 2012

(54) Thermally Stable Optical Element

(75) Inventors: Timothy Kelly, Brookline, MA (US); Terence Yeo, Boston, MA (US)

(73) Assignee: FUSION OPTIX, INC., Woburn, MA (US)

(21) Appl. No.: 13/221,513

(22) Filed: Aug. 30, 2011

Related U.S. Application Data
(60) Provisional application No. 61/406,605, filed on Oct. 26, 2010.

(51) Int. Cl. G02B 5/02; B23P 11/02

(52) U.S. Cl. 359/599; 29/447

(57) ABSTRACT

Designs and manufacturing methods are provided for lighting components and systems with improved performance in luminous efficacy, total lumen output, product lifetime, and form factor through the use of optical composites with improved thermal management. Some embodiments also provide designs and manufacturing methods to minimize thermal warpage and increase the rigidity of optical films and sheets through improved balance of thermal stresses.

### RELATED APPLICATIONS

This application claims the benefit of provisional patent application Ser. No. 61406605 titled “Heat Dissipating Optical Element and Lighting System” filed Oct. 26, 2010 by the present inventors.

### FIELD

The design and manufacture of optical components and light emitting devices and systems are described. Light emitting diodes (LEDs) are used as a light source in example embodiments.

### BACKGROUND

Light emitting devices such as those containing light emitting diodes (LEDs) face challenges in optimizing device efficacy and overall lumen output. Despite having relatively high efficacy compared to other light source types such as incandescent and fluorescent bulbs, LEDs emit a significant amount of heat which increases in relation to the amount of power consumed by the LEDs. Typically LEDs are sensitive to temperature and limiting LED temperature is a critical element of overall performance. Typical LED lighting assemblies include LEDs mounted on circuit boards which are combined with optical components such as lenses and lightguides inside a housing. Examples of high reflectance polymers are described in US patent application publication US 2008/0132614A1 by Jung et al. which discloses a polycarbonate resin composition in which titanium dioxide is used as an active ingredient to achieve high reflectance of visible light.

### SUMMARY

Designs and manufacturing methods are provided for lighting components and systems with improved performance in luminous efficacy, total lumen output, product lifetime, and form factor.

Optical composite embodiments are presented with means for improved thermal management in lighting devices and can be configured for use as light guides or lenses. The optical composites and integrated system designs increase the transfer of heat away from light sources or other temperature sensitive components in lighting devices and transfer heat to regions where it can be dissipated from the lighting device. This is particularly important in LED lighting devices to achieve improved efficacy, higher lumen output, and increased lifetime.

Additionally, thermal warpage can be a problem in lighting devices, especially in cases where a lens or light guide has a large length to thickness aspect ratio. Uneven heating and cooling can cause thermal stresses and can be particularly problematic in lighting devices with light sources mounted close to some but not all edges or surfaces. By better balancing stresses generated by heating and cooling of optical composites comprising lenses and light guides, warping is minimized. In many conventional lighting fixtures and displays this problem is minimized by using relatively large housings or frames that hold discrete components in place. Improved thermal management allows slimmer lighting fixtures and displays utilizing integrated components with improved form factors desirable for user experience, aesthetics, and cost.

Improvements include those realized by advances in the following areas.
1) Novel constructions of integrated optical composites and optical assemblies.
2) Improved thermal transfer of waste heat away from light sources by combination of increased thermal conductance and convective heat loss.
3) Use of custom polymer blends for combined high thermal conductance and high visible light reflectance.

### BRIEF DESCRIPTION OF THE DRAWINGS

FIG. 1 is a diagram showing an optical assembly with integrated thermal management.

FIG. 2 is a diagram showing the enlarged end section of an optical assembly with integrated thermal management.

FIG. 3 is a diagram showing the enlarged end section of an optical composite embodiment.

FIG. 4 is a diagram showing the enlarged end section of an optical composite embodiment.

FIG. 5 is a diagram showing the enlarged end section of an optical composite with light redirecting interface.

FIG. 6 is diagram showing the enlarged end section of a composite lens plus supplemental light redirecting lens in the optical path.

FIG. 7 is an optical assembly embodiment with tapered lightguide.

FIG. 8 is a cross section view of an optical assembly combining 4 optical assemblies of the embodiment in FIG. 7.

FIG. 9 is an emitting surface view of the optical assembly of FIG. 8.

FIG. 10 is an emitting surface view of a composite lens embodiment.

FIG. 11 is a cross section view of the optical composite embodiment from FIG. 10.

FIG. 12 is an emitting surface view of a composite lens embodiment with thermally conductive grid.

FIG. 13 is an cross section view of a composite lens embodiment with thermally conductive grid.

FIG. 14 is a reflectance vs. wavelength plot for a group of thermally conductive polymer samples

### REFERENCE NUMERALS

11 optical assembly
12 thermally conductive material
13 high reflectance material
14 clear polymer lightguide
15 volumetric diffuser
16 Light source
17 Light source assembly
18 lightguide air interface
21 heat exchange fins
31 light redirecting interface
41 supplemental light redirecting lens

### DETAILED DESCRIPTION

The features and other details of the invention will now be more particularly described with reference to the accompanying drawings, in which embodiments of the inventive subject matter are shown. It will be understood that particular embodiments described herein are shown by way of illustration and not as limitations of the invention. However, this inventive subject matter should not be construed as limited to the embodiments set forth herein. Rather, these embodiments are provided so that this disclosure will be thorough and complete, and will fully convey the scope of the inventive subject matter to those skilled in the art. The principal features of this invention can be employed in various embodiments without departing from the scope of the invention.

Several embodiments of the invention are illustrated in the figures and described in detail in the following figure descriptions. Lenses and lightguides can be film or sheet format and may be flexible or rigid. Thermally conductive material is thermally coupled with regions of relative high temperature such as LED packages, circuit boards, transformers, etc. “Thermally coupled” is defined herein as including the coupling, attaching, or adhering two or more regions or layers such that the conductance of heat passing from one region to the other is greater than 0.5 W/mK. As a matter of definition, any material with a thermal conductance equal to or higher than 0.5 W/mK can be considered to be high thermal conductance. An example of a thermal conductive material is a thermally conductive polymer E4505(PC) @4 W/mK or D5108(PPS) @10 W/mK sold by Cool Polymers. This is significantly higher than the typical polycarbonate thermal conductance of about 0.2 W/mK. Additives in thermally conductive polymers which are known to increase thermal conductivity include but are not limited to aluminum, copper, gold, silver, magnesium, zirconium, tungsten, and rhodium.

Thermal bonding is a preferred method of thermally coupling in which two materials are fused together at an elevated temperature and pressure. Examples include extrusion lamination, thermal lamination, insert molding, and hot press bonding.

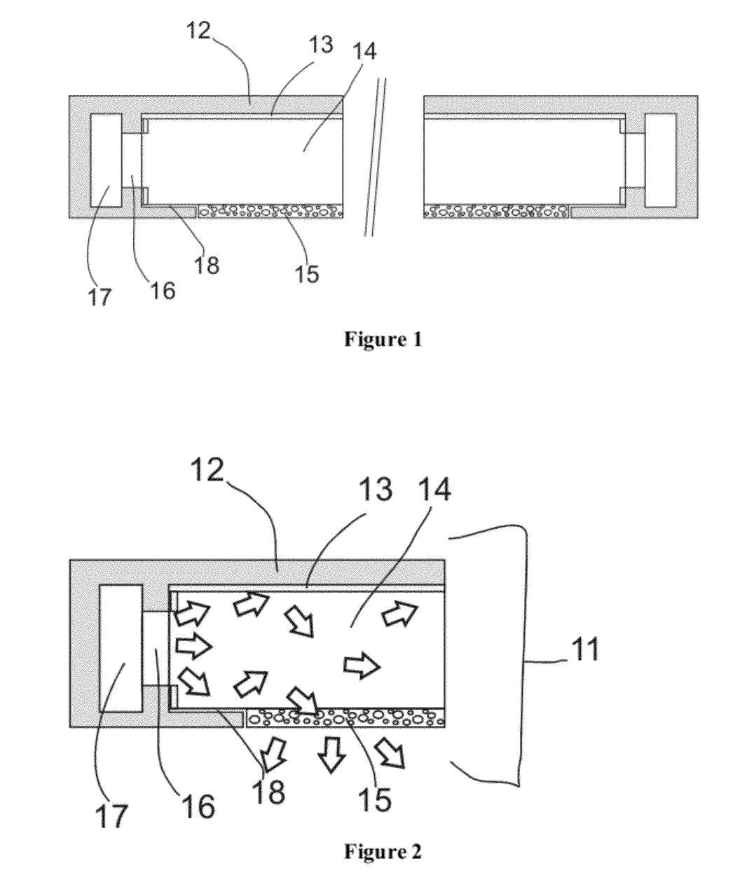

FIGS. 1 and 2 show an optical assembly 11 embodiment with integrated thermal management. Heat is generated by each individual LED light source 16 of an array and conducted to the light source assembly 17. The thermally conductive material 12 is used to encapsulate and connect the light source assembly 17 with the lightguide 14 that comprises a large volume and surface area of the optical assembly 11. A high reflectance material 13 can be used to increased the optical efficiency but is considered optional. In a preferred embodiment, the thermally conductive materials 12 is itself a high reflectance material. This can be achieved by the addition of highly reflective materials such as titanium dioxide, barium sulfate, zirconium dioxide, silica, alumina, or zirconium dioxide, typically in the form of powders.

In a preferred embodiment, an air void between the light guide and thermally conductive material can be used create a index of refraction difference which produces total internal reflection of light for angles of incidence less than a critical angle as defined by Snell's Law,

$${θ}_{crit} = arcsin ( \frac{{η}_{2}}{{η}_{1}} sin {θ}_{2} ) = arcsin \frac{{η}_{2}}{{η}_{1}}$$

where θ₂=90°. η₂ equals the refractive index of the light transmissive matrix, 1.49 in the case of acrylic. η₁ equals the refractive index of the void material, 1 in the case of air. Optical composite embodiments with an air interface near the input edge of the light guide typically achieve improved brightness uniformity of output surface by directing a significant portion of light to outcouple further away from the input edge.

Light guides are comprised of light transmissive material with preferred embodiments using optically clear materials such as acrylic (PMMA), polycarbonate, cyclic olefin copolymer (COC), or glass.

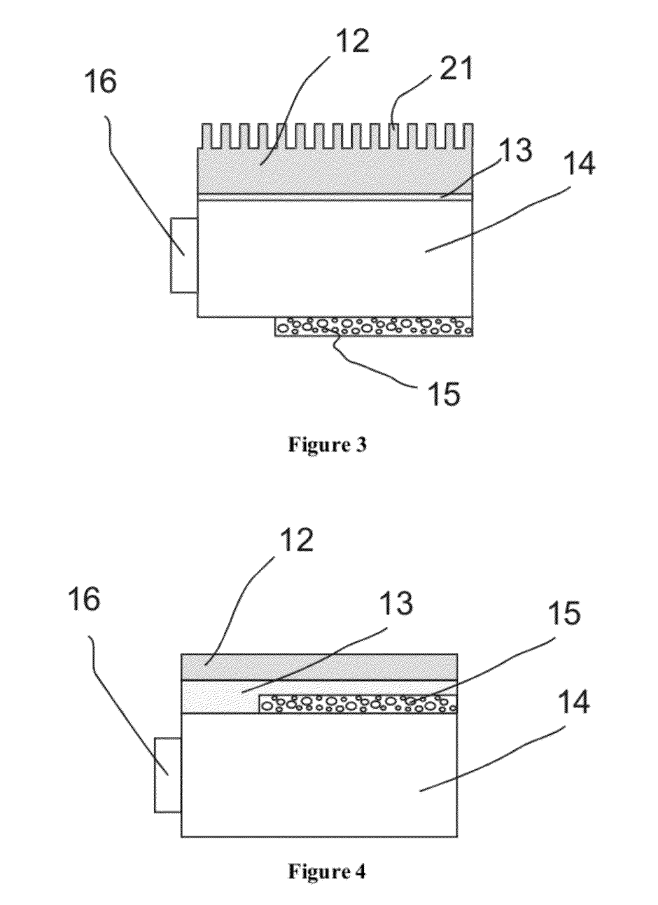

FIG. 3 is a diagram of an optical composite embodiment of the invention in which the thermally conductive material 12 is enhanced with heat sink fins 21 to increase heat transfer.

FIG. 4 is a diagram representing an optical composite embodiment in which the volumetric diffuser 15 is located inside the optical composite adjacent to the high reflectance material layer 13. Optionally the high reflectance layer 13 could be eliminated and reflectance of the thermally conductive material 12 utilized. The clear polymer lightguide 14 is optically coupled to the volumetric diffuser but may or may not be optically coupled to other elements. “Optically coupled” is defined herein as including the coupling, attaching, or adhering two or more regions or layers such that the intensity of light passing from one region to the other is not substantially reduced due to Fresnel interfacial reflection losses due to differences in refractive indices between regions. Optical coupling methods include joining two regions having similar refractive indices, or by using an optical adhesive with a refractive index substantially near or in-between at least one of the regions or layers such as Optically Clear Adhesive 8161 from 3M (with a refractive index at 633 nm of 1.474). Examples of optically coupling include insert molding with injection molding equipment, lamination using an index-matched optical adhesive such as pressure sensitive adhesive: lamination using a UV curable transparent adhesive; lamination using a solvent adhesive; coating a region or layer onto another region or layer; extruding a region or layer onto another region or layer; or hot lamination using applied pressure to join two or more layers or regions that have substantially close refractive indices. A “substantially close” refractive index difference is about 0.5, 0.4, 0.3 or less, e.g., 0.2 or 0.1.

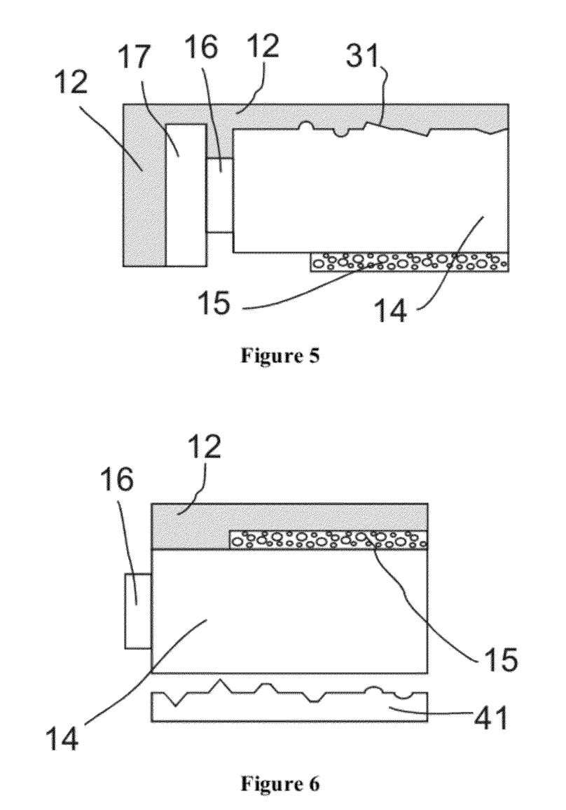

FIG. 5 is a diagram representing an optical composite with light redirecting interface 31. The light redirecting interface 31 contains geometric features to change the interface from a flat planar interface to one in which light is redirected by geometric features such as spheres, ellipses, triangles, pyramids, etc. If a polymer light guide 14 is optically coupled to the interface then redirecting elements will function in a reflective mode. If the polymer light guide 14 is not optically coupled, refraction and internal reflection will also occur and the pattern of the three dimensional features should be designed accordingly to obtain the desired light distribution from the lighting device. As an embodiment of the invention the shape, size, orientation and concentration of redirecting features can be designed to redirect light in a desired distribution. Any interface structures that refract, diffract, or reflect light is within the scope of the invention. The shape, size, orientation and concentration of redirecting features can also be designed with a gradient pattern to provide uniform brightness spatially across the optical composite. Without a gradient pattern brightness will typically be greater near a light source and drop proportionally with distance from the combined input of all light sources incident on a particular place.

FIG. 6 is an embodiment configured with a composite lens plus a supplemental light redirecting lens 41 in the optical path. Any surface feature that refracts, diffracts, or reflects light is within the scope of the invention.

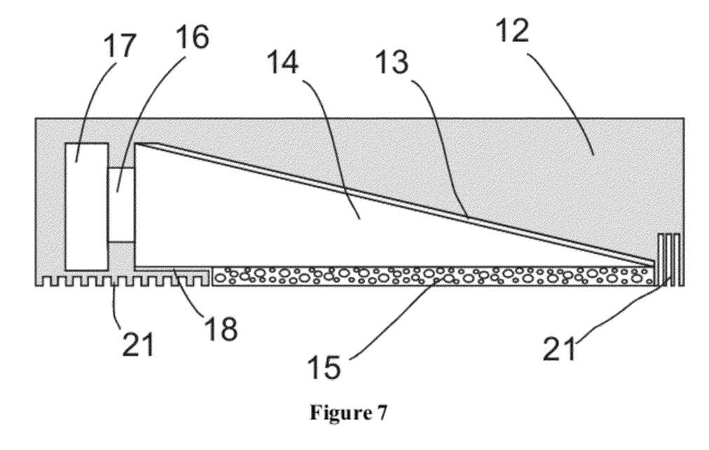

FIG. 7 is an embodiment configured with a tapered light guide. A tapered light guide can be used to increase spatial uniformity by increasing outcoupling as light guide thickness decreases with slope away from light sources. A straight edged wedge is illustrated but other tapered designs are also feasible in which the thickness of the clear light guide 14 is reduced as distance from light source increases.

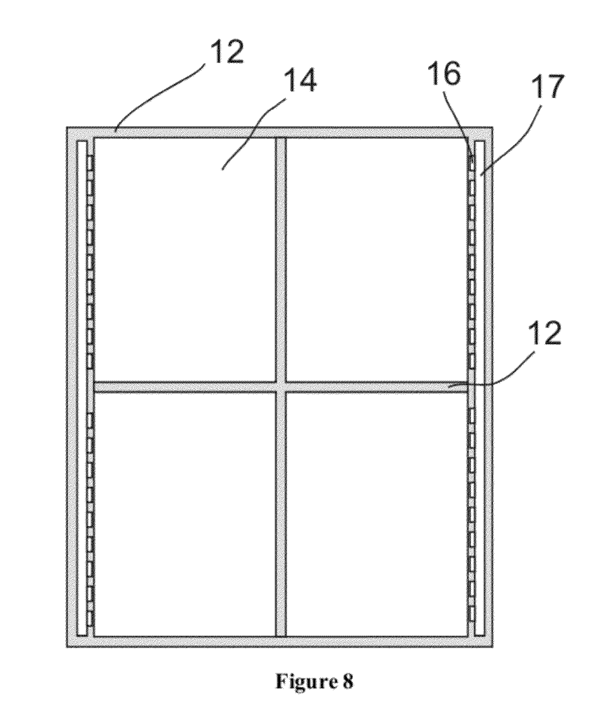

FIG. 8 is a cross section view of an optical assembly combining 4 optical assemblies of FIG. 7 into a lighting device in which the thermally conductive material 12 extends from the LED light source assembly to wrap around the composite lenses on all sides, thereby increasing the transfer of heat away from the LED light sources 16.

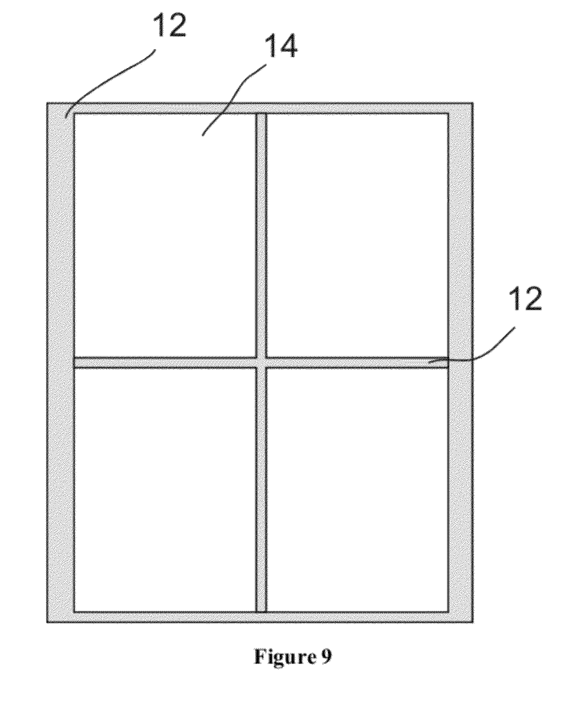

FIG. 9 is a view of the emitting surface of an optical assembly combining 4 optical assemblies of FIG. 7 into a lighting device in which the thermally conductive material 12 extends from the LED light source to wrap around the composite lens on all sides. The large area of the emitting face of the lighting device becomes a heat dissipation component. Unlike the back of lighting device which may be enclosed in many applications, the front light emitting face of the lighting device is typically in open contact with convecting air circulation and even small areas with highly conductive thermal material drawing heat from light sources to the emitting face can have significant cooling effects.

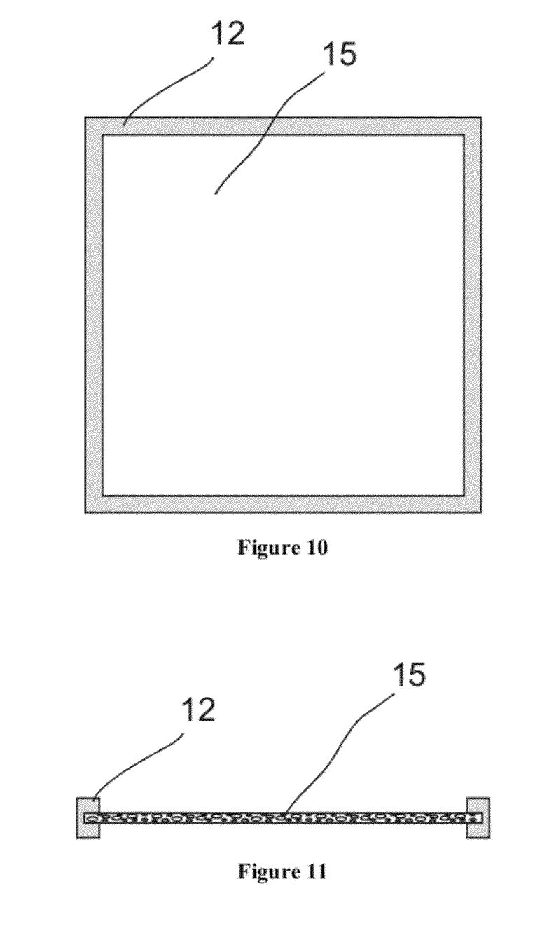

FIG. 10 is an emitting surface view of a composite lens embodiment in which a volumetric diffuser 15 is framed by a thermally conductive material 12.

FIG. 11 is a cross section view of a composite lens embodiment in which a volumetric diffuser 15 is framed by a thermally conductive material 12. With this design, a relatively thin volumetric diffuser with inherently low stiffness can be held rigid and the overall composite lens structure can be made mechanically stable enough to maintain its shape during typical operation. In one embodiment the thermal coefficient of expansion of the thermal conducting material is chosen to be less than the thermal coefficient of expansion of the volumetric diffuser. If the materials are bonded at a temperature higher than the operating temperature range then tensile forces will be imparted on the volumetric diffuser in the plane of the lens upon cooling. These tensile forces will keep the volumetric diffuser planar and free from buckling or warping which will typically be objectionable in commercial applications. If the

The ring shape of the frame illustrated in FIG. 11 is conducive to minimizing thermal warpage of the lens as it uniformly distributes tensile forces which are imparted during heating and cooling of the optical composite after it is bonded. If an optical film or sheet is bonded to the frame at an elevated temperature and then cooled to an operational temperature the frame should have an coefficient of thermal expansion which is less than that of the optical film or sheet. In a manner similar to the spokes in a bicycle wheel, the optical film or sheet distributes tensile forces radially from the center to the perimeter and in the process prevents buckling or sagging of the film or sheet and keeps both the film or sheet and frame from warping due to the balance of forces. When used in a lighting device or system, the frame of the embodiment shown if FIG. 11 may be thermally coupled to other components to aid in heat transfer or it may have limited or no thermal coupling but still function as a means for holding taut an optical film or sheet. In the latter case it is not necessary that the frame be comprised of thermally conductive material but it should have a coefficient of thermal expansion lower than that of an optical film or sheet to which it is thermally bonded.

Alternatively, a frame material with a thermal coefficient of expansion that is greater than the optical film or sheet which it bonds can be utilized to provide uniform tensile forces upon an optical film or sheet by bonding at a temperature lower than the operating temperature and then warming the composite to operating temperature.

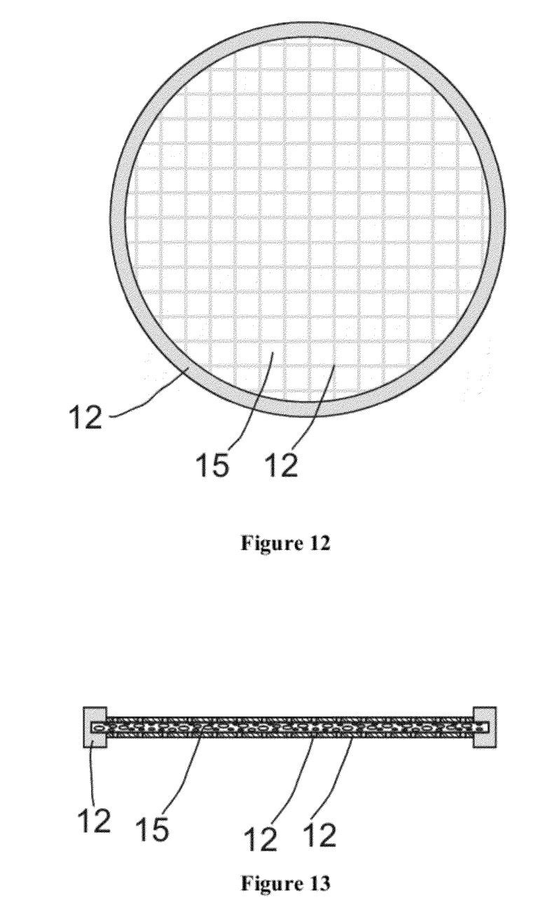

An advantage of the embodiment of FIG. 11 is that the amount of material used is reduced as compared to a typical rigid lens or film plus rigid sheet combination. Since it is held taut by the frame, only a thin film or sheet is required. Consequently, the material reduction also translates into weight and cost savings. Cost savings are further gained in cases where the frame material is less expensive than a volumetric diffuser or other optical films which may substituted into the design. The frames shown in FIG. 11, FIG. 12, and FIG. 13 are simple ring shapes but can alternatively be configured to include additional features that do not substantially interfere with their function of stabilizing tensile forces. Examples of such features include but are not limited to fasteners, holes, attachment pins, positioning posts, mounting clips, etc.

FIGS. 12 and 13 show a composite lens embodiment in which a grid of thermally conductive material 12 is bonded to the surface of a volumetric diffuser 15 and connected to a frame of thermally conductive material. In this manner, the convective surface area can be increased for more effectively cooling the composite lens optical element. The grid blocks the transmission of some light but if the thermally conductive material is also made highly reflective to visible light than light can be recirculated into a lighting device and reemitted. In some embodiments the grid of thermally conductive material can be used to add mechanical stability to the lens and minimize warpage. The dimensions in the figure are not to scale and the width of the grid lines can be made smaller to make them less visible. The thermally conductive material can be bonded to the surface of the volumetric diffuser in a number of ways. As examples, a thermally conductive polymer can be insert molded onto a volumetric diffuser; a thermally conductive ink can be printed onto a volumetric diffuser; a thermally conductive tape can be cut in a grid pattern and laminated to a volumetric diffuser.

The embodiment shown in FIG. 12 and FIG. 13 can be alternatively fabricated either with or without the grid of thermally conductive material. In FIG. 12 and FIG. 13 a volumetric diffuser 15 is framed by a thermally conductive material 12. With this design, a relatively thin volumetric diffuser with inherently low stiffness can be held rigid and the overall composite lens structure can be made mechanically stable enough to maintain its shape during typical operation. In one embodiment the thermal coefficient of expansion of the thermal conducting material is chosen to be less than the thermal coefficient of expansion of the volumetric diffuser. If the materials are bonded at a temperature higher than the operating temperature range then tensile forces will be imparted on the volumetric diffuser in the plane of the lens upon cooling. These tensile forces will keep the volumetric diffuser planar and free from buckling or warping which will typically be objectionable in commercial applications.

The ring shape of the frame illustrated in FIG. 12 is conducive to minimizing thermal warpage of the lens as it uniformly distributes tensile forces which are imparted during heating and cooling of the optical composite after it is bonded. If an optical film or sheet is bonded to the frame at an elevated temperature and then cooled to an operational temperature the frame should have an coefficient of thermal expansion which is less than that of the optical film or sheet. In a manner similar to the spokes in a bicycle wheel, the optical film or sheet distributes tensile forces radially from the center to the perimeter and in the process prevents buckling or sagging of the film or sheet and keeps both the film or sheet and frame from warping due to the balance of forces. FIG. 10 and FIG. 11 represent an embodiment with a rectangular shape. Tensile forces in this design can be held in balance to provide uniform rigidity of optical film or sheet by attaching the frame on two opposing sides only. In this case, for a uniform film or sheet thickness the tensile forces balance along a center line through the optical film or sheet that is midway between the attached sides.

When used in a lighting device or system, the frame of the embodiments shown in FIG. 10, FIG. 11, FIG. 12 and FIG. 13 may be thermally coupled to other components to aid in heat transfer or it may have limited or no thermal coupling but still function as a means for holding taut an optical film or sheet. In the latter case it is not necessary that the frame be comprised of thermally conductive material but it should have a coefficient of thermal expansion lower than that of an optical film or sheet if it is thermally bonded.

Alternatively, a frame material with a thermal coefficient of expansion that is greater than the optical film or sheet which it bonds can be utilized to provide uniform tensile forces upon an optical film or sheet by bonding at a temperature lower than the operating temperature and then warming the composite to operating temperature.

An advantage of the embodiments of FIG. 10, FIG. 11, FIG. 12, and FIG. 13 is that the amount of material used is reduced as compared to a typical rigid lens or film plus rigid sheet combination. Since it is held taut by the frame, only a thin film or sheet is required. Consequently, the material reduction also translates into weight and cost savings. Cost savings are further gained in cases where the frame material is less expensive than a volumetric diffuser or other optical films which may substituted into the design. The frames shown FIG. 12 and FIG. 13 are simple ring shapes but can alternatively be configured to include additional features that do not substantially interfere with their function of stabilizing tensile forces. Examples of such features include but are not limited to fasteners, holes, attachment pins, positioning posts, mounting clips, etc.

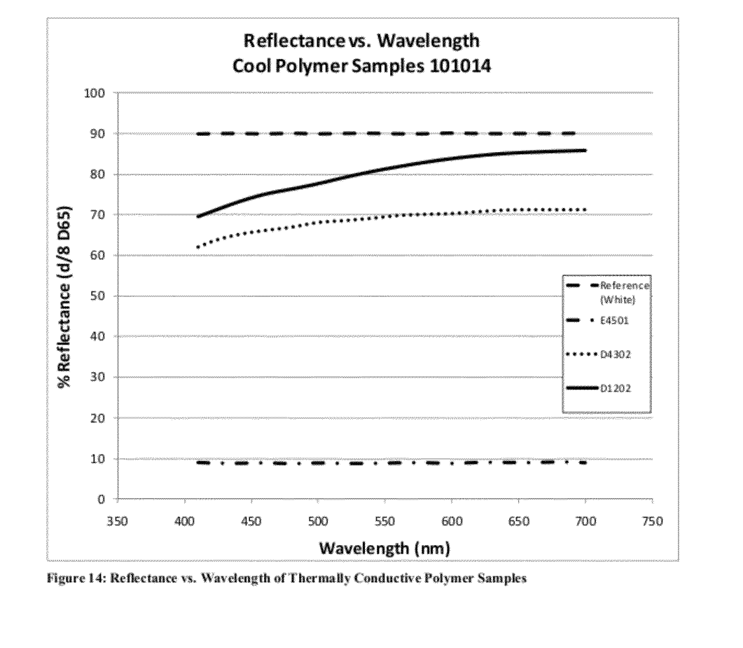

FIG. 14 is a reflectance vs. wavelength plot for a group of thermally conductive samples which were measured with a d/8 reflectance meter, specular component included. Sample D1202 is the most reflective and it shows higher reflectance at longer wavelengths. In an embodiment of the invention this will result in lowering of CCT compared to the CCT of light sources. The thermally conductive polymers of FIG. 14 are not optimized for high reflectance but can be optimized for higher reflectance and lighting device efficacy by the addition of optically reflective materials such as titanium dioxide.

### EQUIVALENTS

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. The contents of all references, issued patents, and published patent applications cited throughout this application are hereby incorporated by reference. The appropriate components, processes, and methods of those patents, applications and other documents may be selected for the invention and embodiments thereof. The contents of all references, including patents and patent applications, cited throughout this application are hereby incorporated by reference in their entirety. The appropriate components and methods of those references may be selected for the invention and embodiments thereof.

What is claimed is:

1. An optical element comprising;
a. an optical film or optical sheet;
b. a frame;
wherein said frame is attached to said optical film or sheet thereby increasing the rigidity of said optical film or optical sheet.

2. An optical element of claim 1 in which said frame and optical film or sheet are attached by thermal bonding.

3. An optical element of claim 1 in which said optical film or optical sheet has a coefficient of thermal expansion lower than or equal to the coefficient of thermal expansion of the said frame.

4. An optical element of claim 1 wherein the frame material is thermally conductive.

5. An optical element of claim 1 additionally comprising a thermally conductive lattice on said light scattering film.

6. An optical element of claim 5 wherein the thermally conductive lattice is also optically reflective.

7. An optical element of claim 1 wherein all attachment locations are substantially equidistant from a center point or center line of said optical film or optical sheet.

8. An optical element of claim 1 wherein said frame is ring shaped.

9. An optical element of claim 1 wherein the optical film is held in tension by the frame.

10. A method of manufacturing an optical element wherein a frame having a coefficient of thermal expansion lower than a optical film or sheet is bonded to said film or sheet at a temperature higher than the operating temperature of the optical element thereby applying tension to the film upon cooling to the operating temperature or below.
